(19) United States
(12) Patent Application Publication
(10) Pub. No.: US 2006/0120842 A1
(43) Pub. Date: Jun. 8, 2006

(54) Vehicle mounted hoist

(76) Inventor: Oliver H. Thompson, Reed City, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/996,220

(22) Filed: Nov. 23, 2004

(51) Int. Cl. B60P 9/00

(52) U.S. Cl. 414/462

(57) ABSTRACT

A hoist for mounting to a vehicle includes a support structure having a support member defining upper and lower portions. The support structure also has a connector adapted to connect the support structure to a vehicle. The support structure further includes a stabilizing member including a ground-engaging portion configured to engage a ground surface. The stabilizing member is adjustably interconnected to the support structure such that the vertical position of the ground-engaging portion of the stabilizing member can be adjusted relative to the support structure. This provides support for the support structure on a ground surface. The hoist further includes a lift connected to the support structure. The lift includes a movable lift member for hoisting an object.

### BACKGROUND OF THE INVENTION

Conventional vehicle-mounted hoists generally include an insertion member that can be inserted into a receiving member of a vehicle (e.g., a trailer and/or towing receiver). Such hoists are typically mounted to a vehicle by insertion into the receiver of a vehicle when a user wants to use the hoist mechanism. Because these hoists are not hard (i.e., permanently) mounted to the vehicle, a user wishing to hoist a heavy and/or awkward object must first install the hoist to the vehicle prior to lifting the object. This means that the user must 1) carry the vehicle mounted hoist with them, most typically either in their vehicle or on their vehicle, and 2) install the hoist prior to hoisting an object. Therefore, using conventional vehicle mounted hoists increases the time it takes to hoist objects, due to the installation of the device.

Therefore, there is a need for a vehicle hoist that alleviates the problems associated with existing hoists.

### SUMMARY OF THE INVENTION

One aspect of the present invention includes a hoist for mounting to a vehicle. The hoist further includes a support structure having a support member defining upper and lower portions. The support structure also has a connector adapted to connect the support structure to a vehicle. The support structure further includes a stabilizing member including a ground-engaging portion configured to engage a ground surface. The stabilizing member is adjustably interconnected to the support structure such that the vertical position of the ground-engaging portion of the stabilizing member can be adjusted relative to the support structure. This provides support for the support structure on a ground surface. The hoist further includes a lift connected to the support structure. The lift includes a movable lift member for hoisting an object.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a vehicle having a vehicle mounted hoist attached thereto according to one aspect of the present invention;

FIG. 2 is a perspective view of a vehicle mounted hoist according to one aspect of the present invention;

FIG. 3 is a fragmentary partial side plan view of a vehicle having a vehicle mounted hoist attached thereto according to one aspect of the present invention;

FIG. 4 is a side plan view of a vehicle mounted hoist according to one aspect of the present invention;

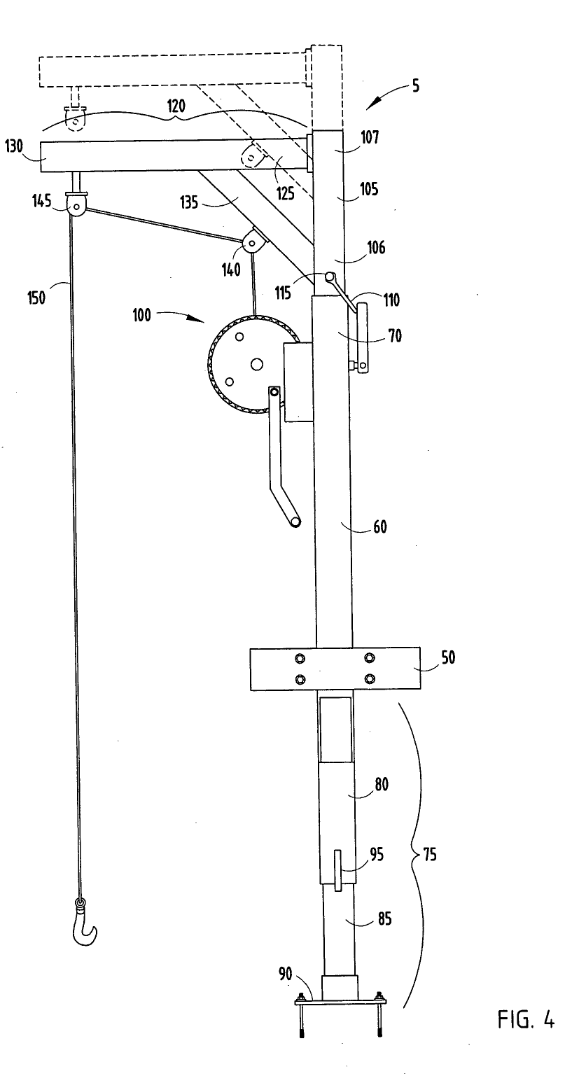

FIG. 5 is a vehicle including a vehicle mounted hoist attached to a non-receiver portion of a vehicle according to one aspect of the present invention; and

FIG. 6 is a side plan view of a vehicle mounted hoist for attachment to a non-receiver of a vehicle according to one aspect of the present invention.

### DETAILED DESCRIPTION OF PREFERRED EMBODIMENT

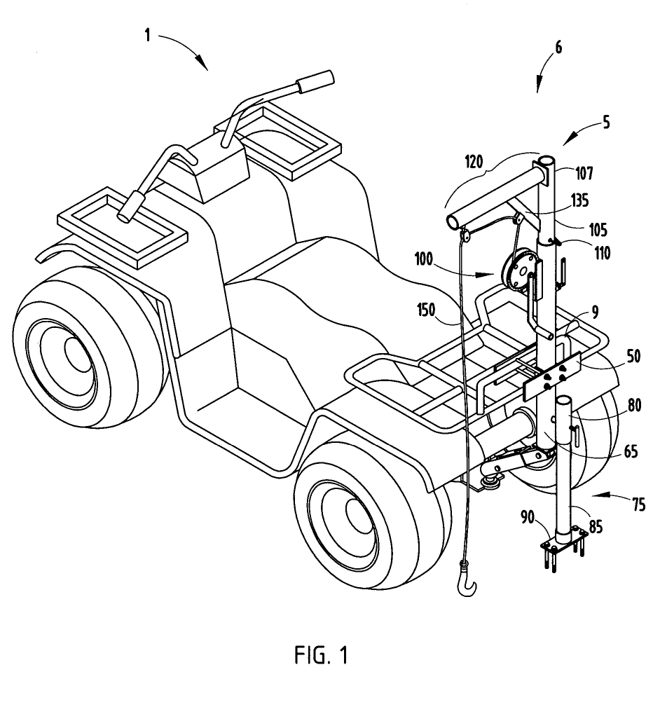

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

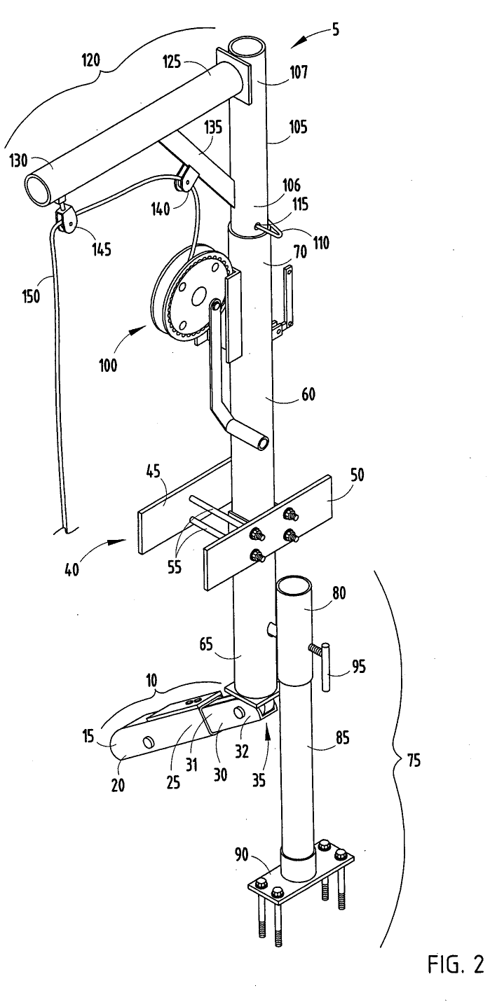

Referring to FIG. 1, reference numeral 6 designates one aspect of the present invention, which is vehicle 1 including vehicle mounted hoist 5 (see also FIG. 2) attached thereto. Vehicle 1 may be operated while the vehicle mounted hoist 5 is attached thereto without hindering or diminishing the suspension (i.e., the travel of the suspension) of the vehicle. The vehicle may be any vehicle having a conventional trailer ball or other attachment/receiver for connecting hoist 5 thereto. Unlike conventional vehicle mounted hoists, the hoist 5 of the present invention does not need to be stored when not in use. Moreover, hoist 5 does not require, aside from the initial installation, time to setup or insert the hoist into or onto the receiver of a vehicle or time to remove the device from the receiver so it can be stored. Rather, hoist 5 of the present invention is permanently mounted to a vehicle having two or more wheels.

Vehicle mounted hoist 5 includes pivotable link or support member 10. Support member 10 generally includes a hitch 15 and adjoining member 30. As discussed in more detail below, pivotable support member 10 and stabilizing apparatus 75 mount hoist 5 to vehicle 1. Hitch 15 is typically a conventional hitch which may be mounted to a receiver of a vehicle via any means, including, but not limited to, a ball, a pin attachment, etc., however, a ball attachment is preferred. Support member 10 typically ranges in length from about 4 inches to about 2 feet, depending upon the requirements of a particular application. As is the case in any conventional ball and hitch connection, the hitch is pivotably attached to the ball. However, there is also some space between the ball and the hitch that allows the hitch to translate in multiple directions on the ball (i.e., when turning corners or traversing uneven terrain) in addition to the pivoting movement. Hitch 15 includes a first end 20 which fits onto a ball of a receiver of a vehicle. Support member 30 includes a first end 31 which is slidably received within a second end 25 of hitch 15, and fixed thereto such that the length of support member 10 is fixed. Support member 30 also includes a second end 32 having a hinged connection 35. Alternately, support member 30 may comprise an extension of hitch 15 that is not slidably received within second end 25 of hitch 15.

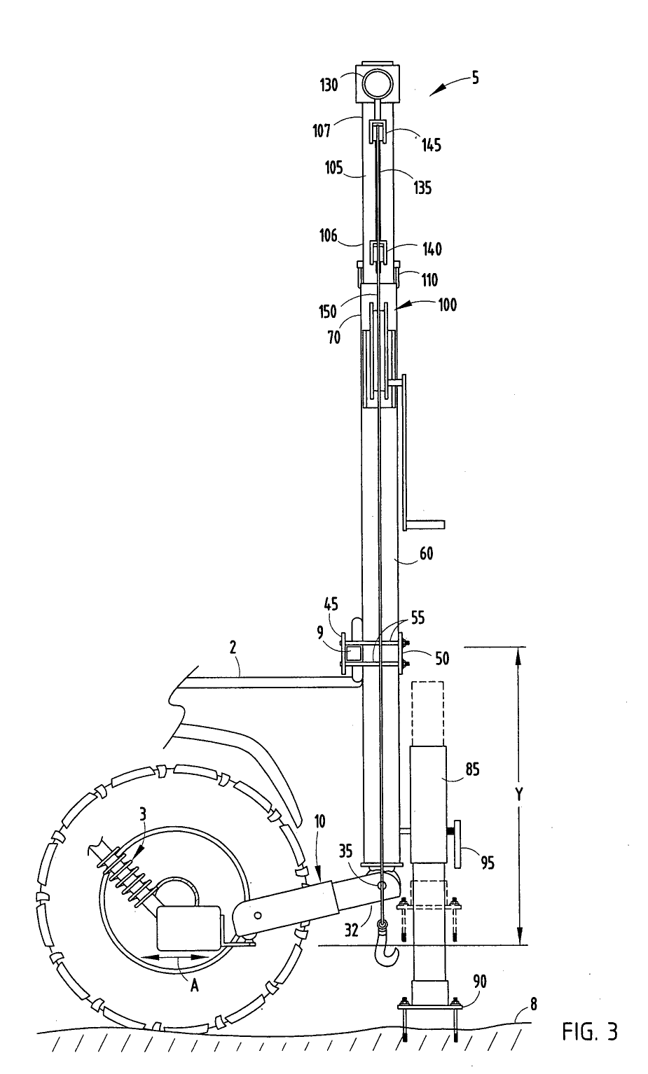

Hinged connection 35 at second end 32 of support member 10 hingedly connects the support member 30 to the first end 65 of a vertically extending support member 60. With further reference to FIG. 3, support member 60 and the remainder of the hoist are rigidly fixed to vehicle frame 2, such that support member 60 moves with frame 2. Receiver 7 (trailer ball) is rigidly mounted to differential 4, and end 20 of support member 10 is connected to receiver 7. When vehicle 1 is in use, irregularities in ground surface 8 cause springs 3 in the vehicle 1 to compress and decompress, such that the frame 2 moves relative to differential 4. This relative movement causes dimensions “Y” to vary. End 32 of support member 10 pivots at hinge 35, and end 20 translates (arrow “A”) due to the clearance between hitch 15 and the trailer ball. Support member 10 thereby supports member 60 in an upright position, while providing for vertical movement of the vehicle hitch/receiver relative to the vehicle frame 2.

With reference back to FIG. 2, support member 60 includes a first end 65 and a second end 70, and ranges in length from about 3 feet to about 10 feet, however, a range of from about 4 feet to 6 feet is preferred. In the illustrated example, support member 60 has a tubular construction that may be any suitable shape or size. Support member 60 may be other shapes, including, but not limited to oval, square, etc., so long as the other parts of vehicle mounted hoist 5 may be attached and slidably attached thereto as necessary. A stabilizing apparatus 75 is attached to first (lower) end 65 of support member 60. Stabilizing apparatus 75 includes receiver cylinder 80 that is welded or otherwise connected to first end 65 of support member 60. A vertically extending stabilizer 85 is smaller in diameter than receiving cylinder 80 and is slidably received within receiving cylinder 80 to provide for vertical adjustment of stabilizer 85. When vehicle mounted hoist 5 is not in use, stabilizer 85 is generally in an “up” position, relative to the ground the vehicle is on. When hoist 5 is to be used, lock member 95 on receiving cylinder 80 is loosened, stabilizer 85 is lowered to rest upon or insert into the ground which the vehicle is resting upon, and lock member 95 is tightened. Lock member 95 may be any type of locking member, however, the most preferred type of lock member is a threaded bolt which has a handle attached to one end so the user may then turn the handle forcing the threaded bolt to place pressure on stabilizer 85. The user may then hand tighten lock member 95 to hold stabilizer 85 in its desired position. Stabilizer 85 includes an immobilizing member 90 which, when in use, rests upon the ground or is inserted into the ground to hold stabilizer 85 in place. In use, stabilizing apparatus 75 keeps support member 60 from moving in a generally down position, relative to the ground the vehicle is resting upon. Therefore, the downward pressure transferred from the weight of the object being hoisted is supported by support member 60 and not at hinged connection 35. Also, member 90 prevents tipping of hoist 5 due to side loads and the like.

First (upper) end 65 of support member 60 also includes hard mounted member 40 that rigidly connects support member 60 to frame 2 of vehicle 1. Hard mounted member 40 includes first plate(s) 45 and second plate(s) 50. First plate(s) 45 and second plate(s) 50 are generally positioned in parallel relationship to one another and have mounting hardware such as threaded fasteners 55 extending therebetween to provide a clamp for clamping to a horizontal frame member 9 of vehicle 1 (see also FIGS. 1 and 3). Most typically, there are four bolts and four nuts that comprise mounting hardware 55. First plate(s) 45 and second plate(s) 50 include one or more apertures extending therethrough, which are aligned with the apertures on the generally opposed parallel plate, with mounting hardware 55 extending therethrough. When installed, threaded fasteners are tightened to permanently hold support member 60 to the frame 2 of vehicle 1. It is conceivable that any type of hard mounted member 40 may be used and adapted to connect to a vehicle.

A conventional manual winch assembly 100 (FIG. 2) is secured to second (upper) end 70 of support member 60. Winch assembly 100 generally includes a flexible member such as cable 150 connecting winch assembly 100 to the object to be hoisted. A support member extension 105 is slidably received in support member 60. Support pin 110 is received in hole 115 to support extension 105 at a selected height. When vehicle mounted hoist 5 is not in use, support member extension 105 may be lowered to its lowest position and securely fastened by inserting support pin 110 through the appropriate support hole 115. In use, support member extension 105 may be slidably extended upwardly and retained at the desired height by inserting support pin 110 into the appropriate support hole 115. Support member extension may extend upwardly from support member 60 a length of from about 2 feet to about 20 feet, however length range of about 3 feet to 4 feet is preferred. It will be appreciated that other manual lift arrangements or electrically powered winch or lift may be utilized.

Support member extension 105 includes a first end 106 and a second end 107. Attached to second end 107 of support member extension 105 is first end 125 of perpendicular cross member 120. This attachment may be any attachment, including, but not limited to, a welded, soldered, glued, tied or other attachment, however, a welded attachment is preferred. Perpendicular cross member 120 includes a first end 125 and a second end 130. Perpendicular cross member 120 is generally perpendicular to support member 60. Perpendicular cross member may be any length, however, a length range of from about 6 inches to about 10 feet is preferred, and a length range of from about 2 feet to about 4 feet is most preferred. Perpendicular cross member 120 may be any shape, including tubular, rectangular, etc., however, a tubular shape is preferred.

A support 135 extends from support member extension 105 to perpendicular cross member 120. Support 135 may be attached to support member extension 105 and perpendicular cross member 120 via welding or other suitable attachment. Support 135 provides additional support for cross member 120 and also supports one or more cable guides such as pulley 140. Flexible member 150 generally extends between winch assembly 100, guide(s) 140, pulley 145 and the object to be lifted. Pulley 145 is positioned generally at the second end 130 of perpendicular cross member 120. The components of vehicle mounted hoist 5 may be constructed of steel or other suitable material.

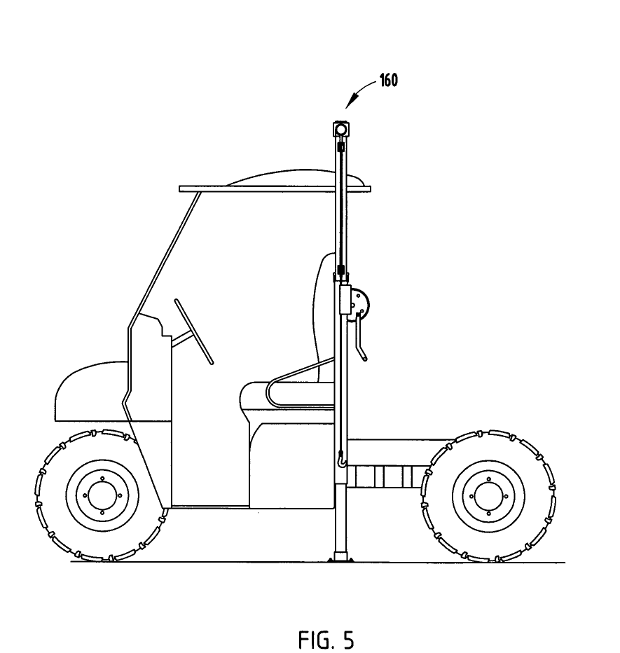

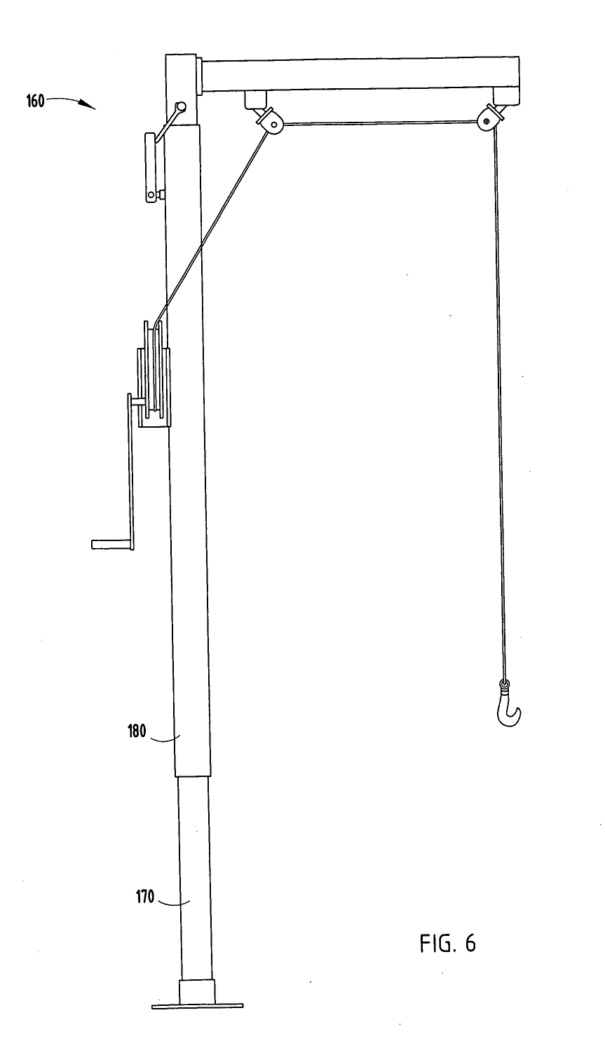

A vehicle mounted hoist 160 (FIG. 5) according to another aspect of the present invention may be attached to a non-receiver portion of a vehicle. With further reference to FIG. 6, hoist 160 generally includes many of the features of vehicle mounted hoist 5 in the previous embodiment. Hoist 160 includes stabilizing apparatus 170 that is similar to stabilizing apparatus 75. However, in this embodiment the stabilizer extends in a downward direction, relative to hoist 160, directly from support member 180. In other words, stabilizing apparatus 170 is in slidable communication with support member 180. Stabilizing apparatus 170 is smaller in diameter (if circular in shape) or smaller in dimensions if some other shape, than support member 180. Hoist 160 may be connected to a frame 2 of vehicle 1 without connection to a trailer/towing receiver. In the illustrated example, support member 180, or an attachment thereof is welded to the frame 2 of vehicle 1 to thereby rigidly secure support member 180 to vehicle 1. Hoist 160 may be lowered, relative to the roof of the vehicle to a height lower than the roof of the vehicle.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A hoist for mounting to an all terrain vehicle, the hoist comprising:
a support structure including a support member defining upper and lower portions, and a stabilizing member including a ground-engaging portion configured to engage a ground surface;
an upper bracket configured to secure the support structure to a cargo rack of an all terrain vehicle;
a link member pivotably connected to the support structure and pivoting about a generally horizontal axis, the link member further including a hitch configured to pivotably connect to a hitch ball of an all terrain vehicle, wherein the hitch moves in a generally vertical arc relative to the support structure as the link member pivots relative to the support structure; and wherein:
the stabilizing member is adjustably interconnected to the support structure such that the vertical position of the ground-engaging portion of the stabilizing member can be adjusted relative to the support structure and provide support for the support structure on a ground surface; and
a lift connected to the support structure, the lift including a movable lift member for hoisting an object.

2-3. (canceled)

4. The hoist of claim 1, wherein the lift includes a handle for manual operation.

5. The hoist of claim 4, wherein the lift connects to the support member.

6. The hoist of claim 5, wherein the lift comprises a winch with a rotatable drum and a rope wound on the drum.

7. The hoist of claim 6, wherein the support member is an elongated upright member.

8. The hoist of claim 7, wherein the stabilizing member slidably engages the support member and extends downwardly therefrom.

9. The hoist of claim 8, wherein the support member is tubular and at least a portion of the stabilizing member is received in the support member.

10. The hoist of claim 9, wherein the ground engaging portion comprises a foot having a plurality of prongs to engage the ground.

11. The hoist of claim 10, further comprising a locking device that locks the position of the stabilizing member relative to the support member at a selected position and transfers loads between the support member and the stabilizing member.

12. The hoist of claim 11, wherein the locking device comprises a threaded member having a handle portion.

13-15. (canceled)

16. A hoist for mounting to an all terrain vehicle, the hoist comprising:
an elongated tubular support member having a sidewall defining cylindrical inner and outer surfaces, an upper opening that opens to an internal cavity, and an end surface around the upper opening at an upper end of the elongated tubular support member;
vertically spaced-apart upper and lower connectors adapted to secure the elongated tubular support member to an all terrain vehicle in a generally upright position;
an elongated upper member having a lower portion telescopically received in the upper opening of the elongated tubular support member and extending into the internal cavity of the elongated tubular support member, the elongated upper member further including a plurality of vertically spaced-apart apertures configured to receive a pin;
a pin received in a selected one of the apertures in the elongated upper member and abutting the end surface of the elongated tubular support member and supporting the elongated upper member at a selected vertical position relative to the elongated tubular support member;
a releasable lock member locking the upper member at the selected vertical position relative to the elongated tubular support;
a generally horizontal cross member secured to an upper end portion of the elongated upper member and defining an outer end;
a lift having a base secured to the support structure and an extensible and retractable elongated flexible member extending from the base to the outer end of the cross member; and
a stabilizing member having a ground-engaging portion, wherein the stabilizing member is adjustably interconnected to the support structure and provides vertical adjustment of the ground-engaging portion relative to the support structure.

17. The hoist of claim 16, wherein:
the ground-engaging portion of the stabilizing member includes a plurality of elongated prongs.

18. The hoist of claim 16, wherein:
the lift comprises a winch with a rotatable drum.

19. The hoist of claim 16, wherein:
the elongated upper member is rotatable relative to the elongated tubular support member about a generally vertical axis.

20. The hoist of claim 16, wherein:
at least one of the upper and lower connectors comprises a clamp.
